(19) United States
(12) Patent Application Publication
(10) Pub. No.: US 2026/0121152 A1
(43) Pub. Date: Apr. 30, 2026

(54) BATTERY CELL INCLUDING A STEEL PRISMATIC BATTERY CAN HAVING A THERMALLY CONDUCTIVE JUNCTION

(71) Applicant: GM GLOBAL TECHNOLOGY OPERATIONS LLC, Detroit, MI (US)

(72) Inventors: Diptak Bhattacharya, Royal Oak, MI (US); Lu Huang, Troy, MI (US); Junjie Ma, Novi, MI (US); William Yu Chen, Troy, MI (US); Matthew A. Celentano, Berkley, MI (US); Ryan P. Hickey, Austin, TX (US); Ryan C. Sekol, Grosse Pointe Woods, MI (US)

(73) Assignee: GM GLOBAL TECHNOLOGY OPERATIONS LLC, Detroit, MI (US)

(21) Appl. No.: 18/931,351

(22) Filed: Oct. 30, 2024

(51) Int. Cl. H01M 10/653; H01M 10/613; H01M 10/625; H01M 10/647; H01M 10/6554; H01M 50/103; H01M 50/119

(52) U.S. Cl. CPC H01M 10/653; H01M 10/613; H01M 10/625; H01M 10/647; H01M 10/6554; H01M 50/103; H01M 50/119

(57) ABSTRACT

A battery cell includes a battery can having a can bottom, a can top, a pair of can side walls, at least one seam, an electrode assembly disposed within the battery can, a thermally conductive junction disposed between the electrode assembly and an inside surface of the can bottom, and a pair of end cap plates. Each of the pair of end cap plates is disposed at opposing ends of the battery can. A top side of the thermally conductive junction is disposed adjacent to bottom edges of the electrode assembly, and a bottom side of the thermally conductive junction is fixedly attached to the inside surface of the can bottom, such that the thermally conductive junction electrically isolates the bottom edges of the electrode assembly from the battery can.

### INTRODUCTION

The concepts described herein relate generally to electrochemical battery cells including, but not limited to, metal enclosures or “cans,” used in the manufacture of prismatic battery cells.

A prismatic battery cell generally includes an electrode assembly or “stack,” disposed within a metal battery can, which is generally rectangular in shape having a bottom, and four walls. The electrode assembly is made up of positive electrodes (cathodes), negative electrodes (anodes) and a separator layer sandwiched together. The stack may also be rolled into a modified jelly roll prior to being disposed within the metal can. Prismatic battery cells are typically stacked in columns and are often used in electric vehicles.

Metal battery cans for Lithium-ion (Li-ion) prismatic battery cells are manufactured from aluminum (Al) using a deep drawing method or are roll-formed. When the battery cell is fabricated, an air gap, which is thermally non-conductive, is created between a bottom end of an electrode assembly and an inside surface of the bottom of the battery can.

For smaller form-factor cells, for example, traditional prismatic battery cells, the air gap is filled with electrolyte, which facilitates heat transfer from the bottom end of the electrode assembly through the electrolyte to the cold plate. However, for larger form-factor cells, the air gap remains in the final prismatic battery cell. As such, in larger form-factor prismatic battery cells that are cooled from the bottom using a cold plate, heat transfer from the bottom end of the electrode assembly to the cold plate is inhibited by the air gap, increasing reliance on the four walls of the battery can alone to transfer heat from the electrode assembly to the cold plate.

Further, the metal battery cans for high density Lithium Nickel Manganese Cobalt Oxide (NMC) prismatic battery cells are manufactured from steel, which has a higher melting resistance than aluminum (Al), to improve thermal runaway protection/propagation (TRP) strategies. However, as steel is heavier than aluminum, transitioning from an aluminum battery can to a steel battery can requires the use of thin-walled steel to maintain mass parity with aluminum.

As steel has a lower thermal conductivity than aluminum, use of a steel battery can in place of an aluminum battery can in a bottom-cooled prismatic battery cell negatively affects the overall cooling efficiency of the bottom-cooled prismatic battery cell. Further, as a heat extraction rate of a bottom-cooled prismatic battery cell decreases with reduced battery can wall thickness, the use of a thin-walled steel battery can raises the operating temperature of the prismatic battery cell, thereby increasing the need for improved thermal performance in thin-walled steel prismatic cells particularly when the battery cells are bottom-cooled using a cold plate.

### SUMMARY

In view of the above discussion, it is useful to develop a prismatic battery cell having a thermally conductive junction between the electrode assembly and the bottom of the battery can, which eliminates the thermally non-conductive air gap between the electrode assembly and the bottom of the battery can, thereby increasing the thermal efficiency of the prismatic battery cell.

An electrochemical battery cell may include a battery can, an electrode assembly disposed within the battery can, and a thermally conductive junction disposed between the electrode assembly and the battery can.

A top side of the thermally conductive junction may be disposed adjacent to bottom edges of the electrode assembly, and a bottom side of the thermally conductive junction may be disposed adjacent to an inside surface of the battery can.

According to one aspect of the disclosure, the bottom side of the thermally conductive junction may be fixedly attached to the inside surface of the battery can.

The thermally conductive junction may include a thermally conductive adhesive, for example but not limited to a thermally conductive double-sided tape, which may have a first layer, a second layer, and a third layer. The third layer may be disposed between the first layer and the second layer.

Each of the first layer and the third layer may include but is not limited to a pressure-sensitive acrylic adhesive, and the second layer may include but is not limited to a polypropylene layer.

The thermally conductive junction may electrically isolate the electrode assembly from the battery can and/or may include a thermal conductivity between 0.1 Watts per meter-Kelvin (W/mK) and 5.0 W/mK.

The battery can may include a can body having a can bottom, a can top, and a pair of can side walls. Each of the pair of can side walls may include a first end perpendicular to the can top and a second end perpendicular to the can bottom.

According to one aspect of the disclosure, the can body may be formed from a single piece of material, for example but not limited to a steel including but not limited to a nickel (Ni) or copper (Cu) plated carbon steel, a stainless steel, and/or aluminum.

The can body may further include at least one seam, which may include for example but not limited to, a weld or a double seam joint line.

According to one aspect of the disclosure, the at least one seam may be disposed along a middle portion of the can top of the battery can.

According to one aspect of the disclosure, the at least one seam may be disposed along a first top edge of the battery can.

According to one aspect of the disclosure, the at least one seam may include a first seam disposed along a first top edge, and a second seam disposed along a second top edge of the battery can.

According to one aspect of the disclosure, the at least one seam may be disposed along a middle portion of one of the pair of can side walls.

According to one aspect of the disclosure, the at least one seam may include a double seamed joint, while according to another aspect of the disclosure, the at least one seam may include a laser welded seam.

According to another aspect of the disclosure, a battery cell may include a battery can having an electrode assembly disposed within the battery can, a pair of end cap plates each of which may be disposed at opposing ends of the battery can, and a thermally conductive double-sided tape disposed between the electrode assembly and an inside surface of the can bottom.

A top side of the thermally conductive double-sided tape may be disposed adjacent to bottom edges of the electrode assembly, and a bottom side of the thermally conductive double-sided tape may be fixedly attached to the inside surface of the can bottom, such that the thermally conductive double-sided tape may electrically isolate the bottom edges of the electrode assembly from the battery can.

The battery can may include a can bottom, a can top, a pair of can side walls, and at least one double seamed joint.

According to another aspect of the disclosure, a battery cell may include a battery can, a pair of end cap plates, an electrode assembly disposed within the battery can, a thermally conductive junction, and a cold plate.

The battery can may include a can bottom, a can top, and a pair of can side walls.

Each of the pair of end cap plates may be disposed at opposing ends of the battery can.

The thermally conductive junction may be disposed between the electrode assembly and an inside surface of the can bottom. A top side of the thermally conductive junction may be disposed adjacent to bottom edges of the electrode assembly, and a bottom side of the thermally conductive junction may be fixedly attached to the inside surface of the can bottom, such that the bottom side of the thermally conductive junction may be opposite the top side of the thermally conductive junction.

The cold plate may be disposed adjacent to an outer surface of the can bottom of the battery can.

A thermal interface layer (TIM) may be disposed between the outer surface of the can bottom and the cold plate.

By including a thermally conductive junction between the bottom edges of the electrode assembly and the inside surface of the bottom of a steel battery can, the thermally non-conductive (resistive) air gap between the electrode assembly and the bottom of the steel battery can is eliminated, allowing heat to be transferred from the electrode assembly to the cold plate through the thermally conductive junction in addition to the pair of can side walls, thereby increasing the thermal efficiency and cooling performance of steel prismatic battery cells, used in, for example but not limited to, a rechargeable energy storage system (RESS) used in an electrified and/or hybrid-electric vehicle as further discussed below.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of an electrified vehicle including both an electric propulsion system and an internal combustion engine according to the present disclosure.

FIG. 2 is a schematic isometric illustration of a battery cell having a thermally conductive junction in accordance with the present disclosure.

FIG. 3 is a schematic cross-sectional illustration of the battery cell in FIG. 1 through section A-A.

FIG. 4(I-IV) are schematic illustrations of a battery cell having a thermally conductive junction and including seam(s) in accordance with the present disclosure.

FIG. 5 is a schematic cross-sectional illustration of a battery cell having a thermally conductive junction and including a cold plate in accordance with the present disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

Referring now to the drawings, wherein like numerals indicate like parts in several views, an electrochemical battery cell including a thermally conductive junction, and an electrified vehicle including a rechargeable energy storage system (RESS) having a plurality of electrochemical battery cells each including a thermally conductive junction are shown and described herein.

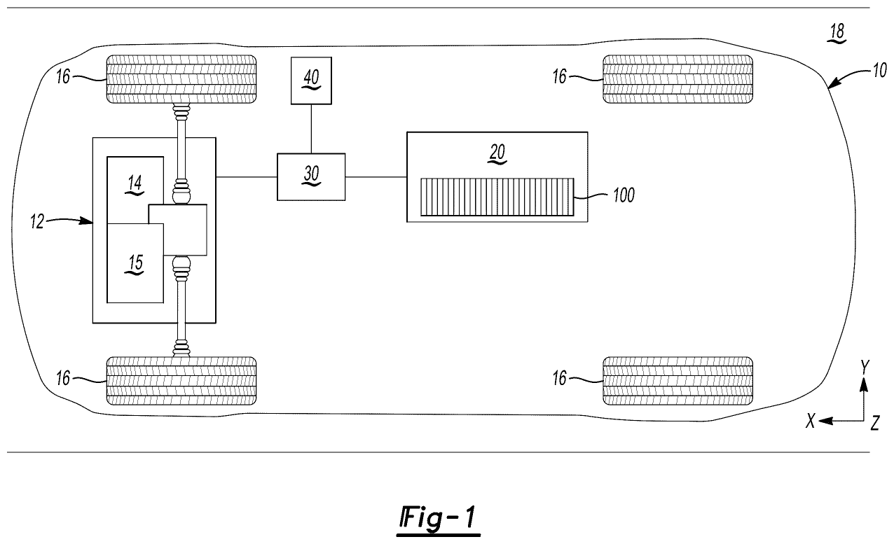

As illustrated in FIG. 1, an electrified vehicle 10 includes a powertrain 12. The electrified vehicle 10 may include, but is not limited to, a commercial vehicle, an industrial vehicle, a passenger vehicle, an aircraft, a watercraft, a train or the like.

The powertrain 12 includes a power-source 14 configured to generate a power-source torque T (not shown) for propulsion of the electrified vehicle 10 via driven wheels 16 relative to a road surface 18. The power-source 14 is depicted as an electric motor-generator.

As further illustrated in FIG. 1, the powertrain 12 may also include an additional power-source 15, for example but not limited to, an internal combustion engine or a fuel cell. The power-sources 14 and 15 may act in concert to power the electrified vehicle 10.

The electrified vehicle 10 includes a rechargeable energy storage system (RESS) 20, a controller 30, and a display 40.

The RESS 20 includes a plurality of electrochemical battery cells 100 and is configured to store electrical power through heat-producing electro-chemical reactions and discharge DC power for energizing the electrified vehicle 10 during use and/or to power a structure, for example, but not limited to a house, during a power disruption or outage.

The controller 30 is in communication with the powertrain 12, the RESS 20, and the display 40. The controller 30 is programmable and may include a central processing unit (CPU) that regulates various functions of the electrified vehicle 10, the RESS 20, and the display 40.

In either of the above configurations, the controller 30 includes a processor and tangible, non-transitory memory, which includes instructions for operation of electrified vehicle 10, the RESS 20, and the display 40 programmed therein. The memory may be an appropriate recordable medium that participates in providing computer-readable data or process instructions. Such a recordable medium may take many forms, including, but not limited to, non-volatile media and volatile media.

Non-volatile media for the controller 30 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the controller 30 may also include a flexible disk, hard disk, magnetic tape, another magnetic medium, a CD-ROM, DVD, another optical medium, etc. The controller 30 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 30 or accessible thereby, including, but not limited to predictive algorithms, may be stored in the memory and automatically executed to provide the required functionality of the electrified vehicle 10, the RESS 20, and the display 40.

The controller 30 is disposed in the electrified vehicle 10 and is in communication with the powertrain 12, the RESS 20, the display 40, and the electrified vehicle 10.

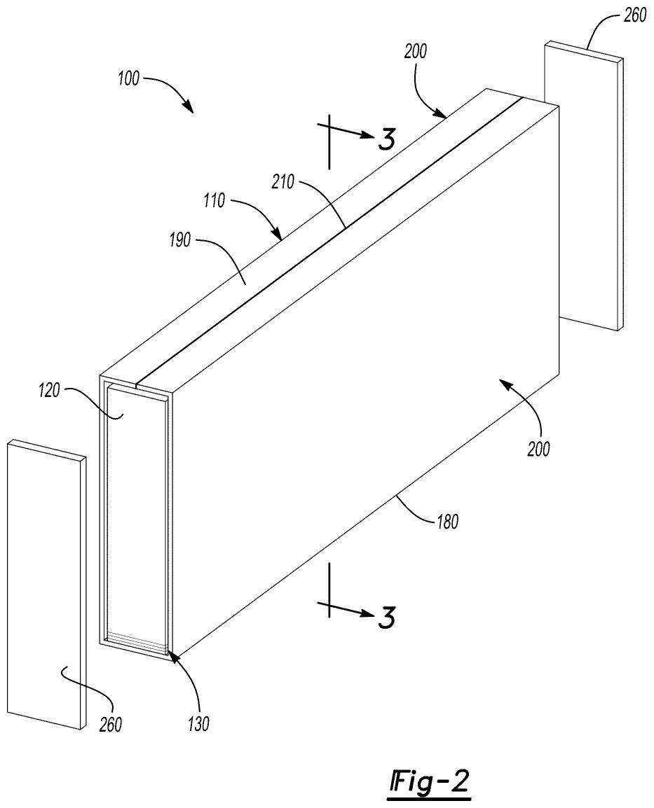

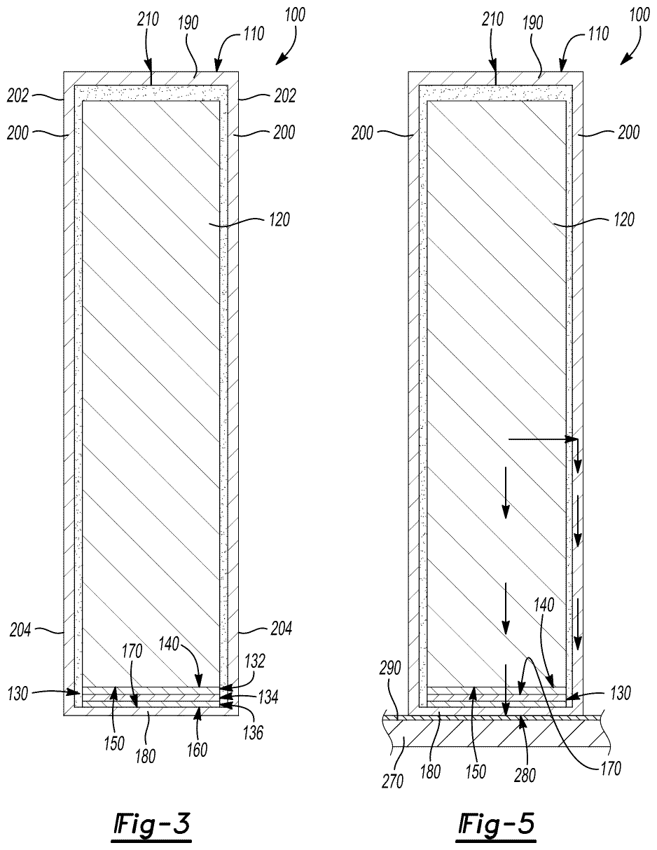

As generally illustrated in FIG. 2, an electrochemical battery cell 100 is shown. The battery cell 100 includes a battery can 110, an electrode assembly 120 disposed within the battery can 110, and a thermally conductive junction 130 disposed between the electrode assembly 120 and the battery can 110.

A top side 140 of the thermally conductive junction 130 is disposed adjacent to bottom edges 150 of the electrode assembly 120, and a bottom side 160 of the thermally conductive junction 130 is disposed adjacent to an inside surface 170 of the battery can 110.

According to one aspect of the disclosure, the bottom side 160 of the thermally conductive junction 130 is fixedly attached to the inside surface 170 of the battery can 110.

As illustrated in FIG. 2, the thermally conductive junction 130 includes a thermally conductive adhesive, for example but not limited to a thermally conductive double-sided tape, which may include but is not limited to a double-sided electrolyte compatible polypropylene tape having a thermal conductivity of 0.1 Watts per meter-Kelvin (W/mk)-5.0 W/mK, and a melting temperature greater than 150° Celsius.

The thermally conductive double-sided tape 130 includes a first layer 132, a second layer 134, and a third layer 136 disposed between the first layer 132 and the second layer 134.

The first layer 132 and the third layer 136 may include but is not limited to a pressure-sensitive acrylic adhesive, and the second layer 134 may include but is not limited to a polypropylene layer.

The first layer 132 and the third layer 136 may each include a thickness of approximately 5 μm, while the second layer 134 may include a thickness of approximately 25 μm.

The thermally conductive junction 130 electrically isolates the electrode assembly 120 from the battery can 110 and/or may include a thermal conductivity between 0.1 W/mK and 5.0 W/mK.

The battery can 110 includes a can body 115 having a can bottom 180, a can top 190, and a pair of can side walls 200, each of the pair of can side walls 200 having a first end 202 perpendicular to the can top 190 and a second end 204 perpendicular to the can bottom 180.

According to one aspect of the disclosure, the can body 115 is formed from a single piece of material, for example but not limited to a steel including but not limited to a nickel (Ni) or copper (Cu) plated carbon steel, and/or a stainless steel.

The can body 115 further includes at least one seam 210.

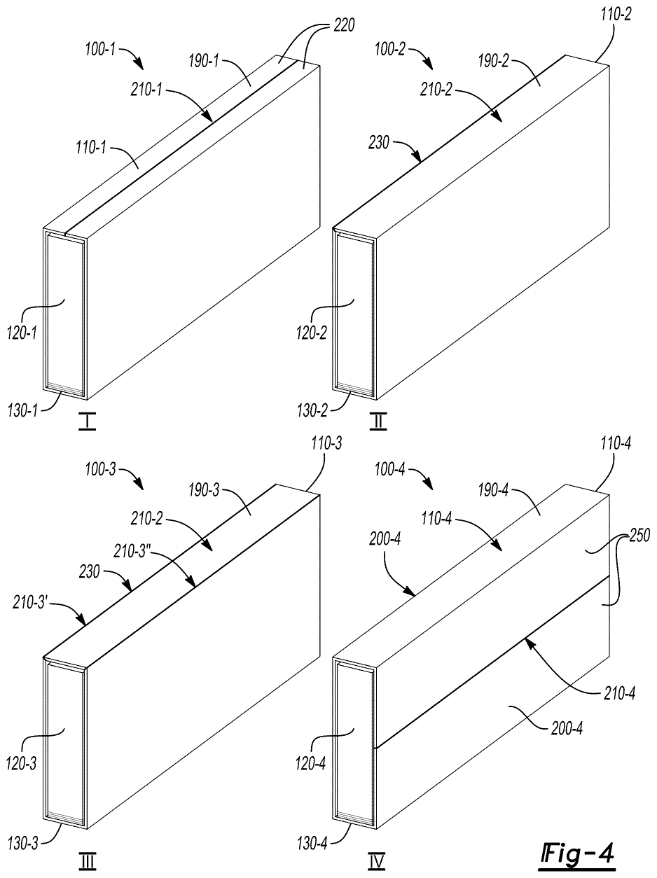

As schematically illustrated in FIG. 4(I), an electrochemical battery cell 100-1 includes a battery can 110-1 having a can top 190-1, an electrode assembly 120-1 disposed within the battery can 110-1, and a thermally conductive junction 130-1 disposed between the electrode assembly 120-1 and the battery can 110-1.

According to one aspect of the disclosure, the at least one seam 210-1 is disposed along a middle portion 220 of the can top 190-1 of the battery can 110-1.

As schematically illustrated in FIG. 4 (II), an electrochemical battery cell 100-2 includes a battery can 110-2 having a can top 190-2, an electrode assembly 120-2 disposed within the battery can 110-2, and a thermally conductive junction 130-2 disposed between the electrode assembly 120-2 and the battery can 110-2.

According to one aspect of the disclosure, the at least one seam 210-2 is disposed along a first top edge 230 of the battery can 110-2.

As schematically illustrated in FIG. 4 (III), an electrochemical battery cell 100-3 includes a battery can 110-3 having a can top 190-3, an electrode assembly 120-3 disposed within the battery can 110-3, and a thermally conductive junction 130-3 disposed between the electrode assembly 120-3 and the battery can 110-3.

According to one aspect of the disclosure, the at least one seam 210-3′, 210-3″ includes a first seam 210-3′ disposed along a first top edge 230, and a second seam 210-3″ is disposed along a second top edge 240 of the battery can 110-3.

In this configuration, the first seam 210-3′ disposed along the first top edge 230, and the second seam 210-3″ disposed along the second top edge 240 of the battery can 110-3 provide a gap, which may act as a vent manifold.

As schematically illustrated in FIG. 4 (IV), an electrochemical battery cell 100-4 includes a battery can 110-4 having a can top 190-4, an electrode assembly 120-4 disposed within the battery can 110-4, and a thermally conductive junction 130-4 disposed between the electrode assembly 120-4 and the battery can 110-4.

According to one aspect of the disclosure, the at least one seam 210-4 is disposed along a middle portion 250 of one of the pair of can side walls 200-4.

According to one aspect of the disclosure, the at least one seam 210 includes a double seamed joint, according to another aspect of the disclosure, the at least one seam 210 includes a laser welded seam.

Referring back to FIG. 2, a battery cell 100 includes a battery can 110 having an electrode assembly 120 disposed within the battery can 110, a pair of end cap plates 260 each of which is disposed at opposing ends of the battery can 110, and a thermally conductive double-sided tape 130 disposed between the electrode assembly 120 and an inside surface 170 of the can bottom 180.

A top side 140 of the thermally conductive double-sided tape 130 is disposed adjacent to bottom edges 150 of the electrode assembly 120, and a bottom side 160 of the thermally conductive double-sided tape 130 is fixedly attached to the inside surface 170 of the can bottom 180, such that the thermally conductive double-sided tape 130 electrically isolates the bottom edges 150 of the electrode assembly 120 from the battery can 110.

The battery can 110 includes a can bottom 180, a can top 190, a pair of can side walls 200, and at least one double seamed joint 210.

Each of the pair of end cap plates 260 may include battery terminals (not shown) and/or vents (not shown).

As illustrated in FIG. 5 with continued reference to FIG. 2, a battery cell 100 includes a battery can 110, a pair of end cap plates 260, an electrode assembly 120 disposed within the battery can 110, a thermally conductive junction 130, and a cold plate 270.

The battery can 110 includes a can bottom 180, a can top 190, and a pair of can side walls 200.

Each of the pair of end cap plates 260 is disposed at opposing ends of the battery can 110.

The thermally conductive junction 130 is disposed between the electrode assembly 120 and an inside surface 170 of the can bottom 180. A top side 140 of the thermally conductive junction 130 is disposed adjacent to bottom edges 150 of the electrode assembly 120, and a bottom side 160 of the thermally conductive junction 130 is fixedly attached to the inside surface 170 of the can bottom 180, such that the bottom side 160 of the thermally conductive junction 130 is opposite the top side 140 of the thermally conductive junction 130.

The cold plate 270 is disposed adjacent to an outer surface 280 of the can bottom 180 of the battery can 110.

A thermal interface material (TIM) 290 is disposed between the outer surface 280 of the can bottom 180 and the cold plate 270. The TIM 290 is an adhesive that may include a thermally conductive material to aid in transferring heat from the can bottom 180 of the battery can 110 to the cold plate 270.

The thermally conductive junction 130 decreases reliance on the pair of can side walls 200 to conduct heat away from the electrode assembly 120 through the pair of can side walls 200 to the cold plate 270 via Path 1, by providing an additional path, Path 2, in which heat can also be conducted away from the electrode assembly 120 through the thermally conductive junction 130 to the cold plate 270, exploiting both Path 1 and Path 2, thereby increasing the cooling efficiency of the battery cell 100.

By including a thermally conductive junction between the bottom edges of the electrode assembly and the inside surface of a steel battery can, the thermally non-conductive (resistive) air gap between the electrode assembly and the bottom of the battery can is eliminated, allowing heat to be transferred to the cold plate through thermally conductive junction in addition to the pair of can side walls, thereby increasing the thermal efficiency and cooling performance of the prismatic battery cell.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A battery cell comprising:
a battery can;
an electrode assembly disposed within the battery can; and
a thermally conductive junction disposed between the electrode assembly and the battery can, wherein a top side of the thermally conductive junction is disposed adjacent to bottom edges of the electrode assembly, and a bottom side of the thermally conductive junction is disposed adjacent to an inside surface of the battery can.

2. The battery cell as recited in claim 1, wherein the bottom side of the thermally conductive junction is fixedly attached to the inside surface of the battery can.

3. The battery cell as recited in claim 2, wherein the thermally conductive junction includes a thermally conductive adhesive.

4. The battery cell as recited in claim 3, wherein the thermally conductive adhesive includes a thermally conductive double-sided tape.

5. The battery cell as recited in claim 4, wherein the thermally conductive double-sided tape includes a first layer, a second layer, and a third layer, wherein the second layer is disposed between the first layer and the second layer.

6. The battery cell as recited in claim 5, wherein the first layer and the third layer include a pressure-sensitive acrylic adhesive, and the second layer includes a polypropylene layer.

7. The battery cell as recited in claim 1, wherein the thermally conductive junction electrically isolates the electrode assembly from the battery can.

8. The battery cell as recited in claim 1, wherein the thermally conductive junction includes a thermal conductivity between 0.1 W/mK and 5.0 W/mK.

9. The battery cell as recited in claim 1, wherein the battery can includes a can body having a can bottom, a can top, and a pair of can side walls, each of the pair of can side walls having a first end perpendicular to the can top and a second end perpendicular to the can bottom.

10. The battery cell as recited in claim 9, wherein the can body is formed from a single piece of material.

11. The battery cell as recited in claim 10, wherein the can body further includes at least one seam.

12. The battery cell as recited in claim 11, wherein the at least one seam includes a double seamed joint.

13. The battery cell as recited in claim 12, wherein the at least one double seamed joint is disposed along a middle portion of the can top.

14. The battery cell as recited in claim 12, wherein the at least one double seamed joint is disposed along a first top edge of the battery can.

15. The battery cell as recited in claim 12, wherein the at least one double seamed joint includes a first double seamed joint disposed along a first top edge of the battery can, and a second double seamed joint disposed along a second top edge of the battery can.

16. The battery cell as recited in claim 12, wherein the at least one double seamed joint is disposed along a middle portion of one of the pair of can side walls.

17. The battery cell as recited in claim 10, wherein the material is steel.

18. The battery cell as recited in claim 11, wherein the at least one seam includes a laser welded seam.

19. A battery cell comprising:
a battery can having:
a can bottom;
a can top;
a pair of can side walls; and
at least one double seamed joint; and
a pair of end cap plates, each of the pair of end cap plates disposed at opposing ends of the battery can;
an electrode assembly disposed within the battery can; and
a thermally conductive double-sided tape disposed between the electrode assembly and an inside surface of the can bottom, wherein a top side of the thermally conductive double-sided tape is disposed adjacent to bottom edges of the electrode assembly, and a bottom side of the thermally conductive double-sided tape is fixedly attached to the inside surface of the can bottom, wherein the thermally conductive double-sided tape electrically isolates the bottom edges of the electrode assembly from the battery can.

20. An electrified vehicle comprising:
a vehicle body;
a powertrain disposed within the vehicle body, the powertrain including a power-source;
a plurality of wheels driven by the powertrain, wherein the powertrain is configured to generate a power-source torque for propulsion of the electrified vehicle via the plurality of driven wheels relative to a road surface;
a rechargeable energy storage system (RESS) including a plurality of battery cells, disposed within the vehicle body, wherein the RESS is configured to store electrical power within the plurality of battery cells, and discharge the electrical power from the plurality of battery cells to the powertrain to generate the power-source torque, wherein each of the plurality of battery cells includes:
a battery can including:
a can bottom;
a can top; and
a pair of can side walls; and
a pair of end cap plates, each of the pair of end cap plates disposed at opposing ends of the battery can;
an electrode assembly disposed within the battery can;
a thermally conductive junction disposed between the electrode assembly and an inside surface of the can bottom, wherein a top side of the thermally conductive junction is disposed adjacent to bottom edges of the electrode assembly, and a bottom side of the thermally conductive junction is fixedly attached to the inside surface of the can bottom, wherein the bottom side of the thermally conductive junction is opposite the top side of the thermally conductive junction; and
a cold plate disposed adjacent to an outer surface of the can bottom.
